(19) United States
(12) Patent Application Publication
(10) Pub. No.: US 2022/0289456 A1
(43) Pub. Date: Sep. 15, 2022

(54) Temperature Controlled Medicine Holder

(71) Applicant: Michael Chou, South Lyon, MI (US)

(72) Inventor: Michael Chou, South Lyon, MI (US)

(21) Appl. No.: 17/201,364

(22) Filed: Mar. 15, 2021

(51) Int. Cl. B65D 81/20; A61J 1/03

(52) U.S. Cl. CPC B65D 81/2015; A61J 1/03

(57) ABSTRACT

A portable container for keeping medicine in a temperature controlled environment by means of an insulating layer of vacuum in the walls and cap of the container. The container has a cap or closure that is not only vacuum insulated but is designed to be very easily removed in an emergency. Inside the container is foam cushioning that serves as a crumple zone to protect the medicine in the event the container is dropped or otherwise sustains an impact. The container also contains a thermometer which can be used to determine that the medicine has not been subjected to any extreme temperatures outside the range of tolerance for the medicine. Inside the walls of the container where there is insulating vacuum, there is structure to keep the container from deforming.

### CROSS-REFERENCE TO RELATED APPLICATIONS

This application claims the benefit of the Mar. 16, 2020 filing date of Provisional Application No. 63/100,485 pursuant to 35 U.S.C. § 119(e).

### STATEMENT REGARDING FEDERALLY SPONSORED RESEARCH AND DEVELOPMENT

This invention was not made using federally sponsored research and development. The inventors retain all rights.

### THE NAMES OF THE PARTIES TO A JOINT RESEARCH AGREEMENT

There is no joint research agreement.

### BACKGROUND OF THE INVENTION

This invention falls within the field of portable medicine containers and more particularly, temperature controlled portable medicine containers. Many medicines require storage at a specific narrow temperature range. Epipens, used for emergency treatment of anaphylactic shock, must be maintained between 66° to 75° Fahrenheit. People may find themselves in much hotter or colder temperatures than that and yet still need to carry their life saving Epipen.

### BRIEF SUMMARY OF THE INVENTION

In summary, this invention solves the problem of persons needing to carry life sustaining medications that are perishable while out in hot or cold weather carrying on their daily activities. It accomplishes this by means of an insulating layer of vacuum in the walls and cap of the container.

### BRIEF DESCRIPTION OF THE SEVERAL VIEWS OF THE DRAWINGS

FIG. 1 shows an exploded view of the invention.

FIG. 2 shows a side sectional view of the invention.

FIG. 3 shows a detail view of a feature to help remove the top cap.

FIG. 4 shows a perspective view of the invention.

FIG. 5 shows a perspective view of the invention including details of the belt clip.

FIG. 6 shows a sectional view of the invention.

FIG. 7 shows a sectional view of the invention.

FIG. 8 shows a case subjected to atmospheric pressure.

FIG. 9 shows deformation to a case caused by atmospheric pressure with no support structure in the hollow interior.

FIG. 10 shows a case having crossed internal support structures in the hollow interior.

FIG. 11 shows the case with interior support having less pressure deformation.

FIG. 12 shows the case with a vertical interior support structure in the hollow interior.

FIG. 13 shows the case with interior support having less pressure deformation.

FIG. 14 shows a case with vertical and horizontal support structures in the hollow interior.

FIG. 15 shows the case with interior support having less pressure deformation.

### DETAILED DESCRIPTION OF THE INVENTION

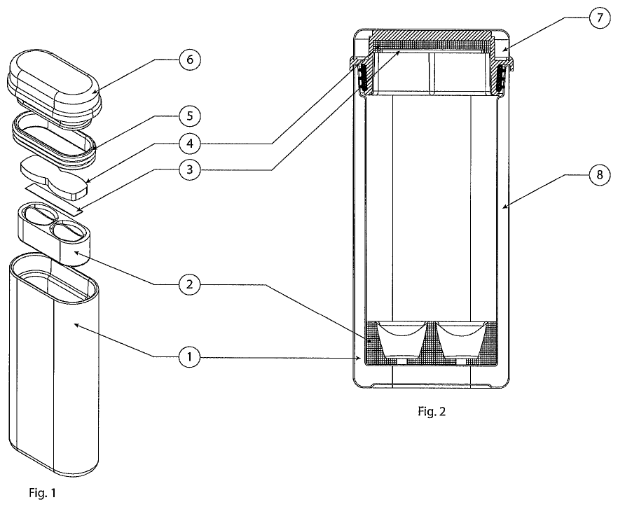

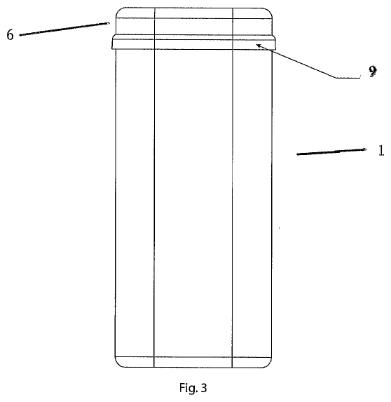

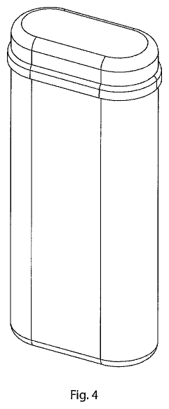

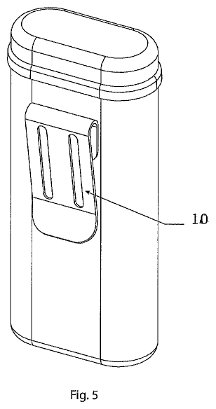

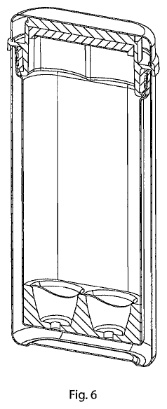

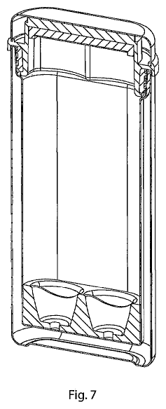

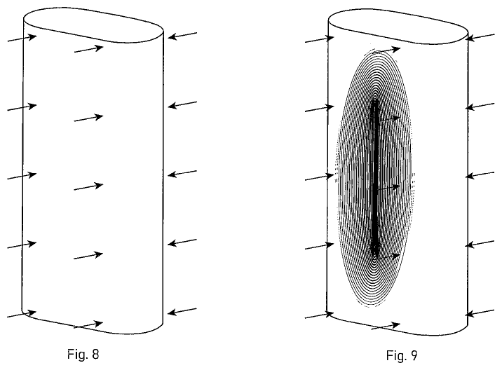

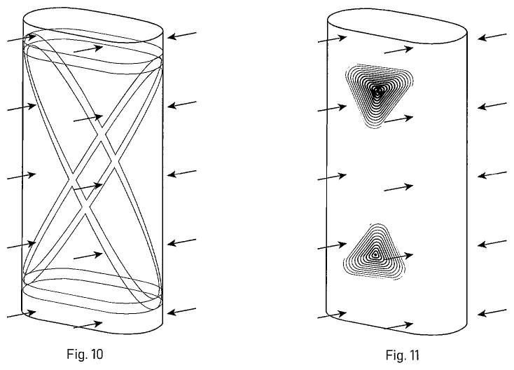

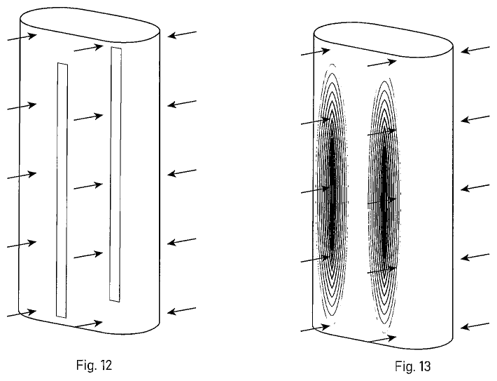

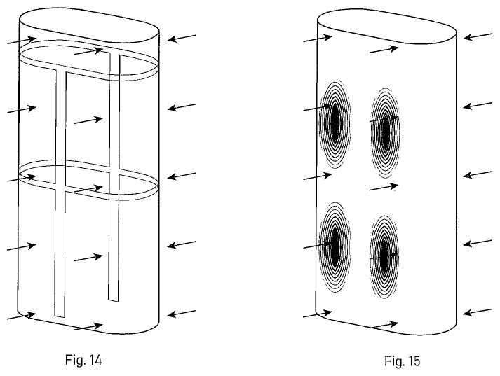

This invention solves the problem of persons needing to carry life sustaining medications that are perishable while out in hot or cold weather carrying on their daily activities. It accomplishes this by means of an insulating layer of vacuum in the walls and cap of the container. The container has a cap or closure that is not only vacuum insulated but is designed to be very easily removed in an emergency. Inside the container is foam cushioning that serves as a crumple zone to protect the medicine in the event the container is dropped or otherwise sustains an impact. The container also contains a thermometer which can be used to determine that the medicine has not been subjected to any extreme temperatures outside the range of tolerance for the medicine. Turning now to FIG. 1, the preferred embodiment can be seen to comprise an elongate case (1) with a substantially oval cross section and a hollow interior. A foam cradle (2) is placed in the bottom of the interior. The preferred embodiment also has a lid (6) which is fitted with a silicone gasket (5), another piece of foam (4), and a thermometer tape (3). Turning to FIG. 2, the case (1) can be seen to employ vacuum space (8) in its walls together with the silicone gasket to keep the interior temperature constant. The lid (6) also has a vacuum space (7) to keep the interior temperature constant. Turning now to FIG. 3, the lid (6) can be seen to have a slight protrusion (9) or ridge which is adapted to facilitate easy opening of the medicine holder in the event of an emergency. Turning now to FIG. 5, a clip (10) is shown by which the Medicine Holder can be stored on a belt or pocket. FIGS. 8 through 15 illustrate the utility of having support structures inside the hollow interior of the case. When vacuum is created in the hollow interior, atmospheric pressure on the outside can cause deformation of the case. This is the situation illustrated by FIGS. 8 and 9. Support structures inside the hollow interior can prevent this deformation. In a preferred embodiment, the support structures allow air to be removed from the hollow interior from one point on the case. In other words, the support structures do not fully wall off multiple separate chambers within the hollow interior. The support structures may cross diagonally within the hollow interior as seen in FIGS. 10 and 11, they may be in the form of a support structure parallel with the long axis of the case as seen in FIGS. 12 and 13, or they may take the form of crossing vertical and horizontal structures as seen in FIGS. 14 and 15.

The inventor expressly does not wish to be limited to the embodiment shown and intends to avail himself of the full scope of his rights under the doctrine of equivalents.

I claim:

1. A container for temperature sensitive medicine comprising a case and a lid; said case having an inside forming a mouth, an outside, and a first vacuum space; said inside having bottom foam adapted to conform to the end of the temperature sensitive medicine; said outside having a support structure; said inside and said outside enclosing said first vacuum space; said lid having an interior, an exterior, and a second vacuum space; said interior having top foam adapted to conform to the end of the temperature sensitive medicine and a thermometer; said exterior having a protrusion, and a gasket adapted to seal said mouth; said interior and said exterior enclosing said second vacuum space.

2. The container of claim 1 further comprising a clip on said outside.

3. The container of claim 1 wherein said support structure comprises thickened wall regions adapted to resist pressure deformation of said outside.

4. The container of claim 1 further comprising a clip on said outside and said support structure having thickened wall regions adapted to resist pressure deformation of said outside.
